(19) United States
(12) Patent Application Publication
(10) Pub. No.: US 2015/0056324 A1
(43) Pub. Date: Feb. 26, 2015

(54) ARCHER DANIELS MIDLAND COMPANY

(71) Applicant: ARCHER DANIELS MIDLAND COMPANY, Decatur, IL (US)

(72) Inventors: Michael Cecava, Monticello, IL (US); Perry Doane, Decatur, IN (US); Alan Grusby, Champaign, IL (US); Glenn Kimball, Fairfax, IA (US)

(21) Appl. No.: 14/526,819

(22) Filed: Oct. 29, 2014

Related U.S. Application Data
(63) Continuation of application No. PCT/US13/38794, filed on Apr. 30, 2013.
Application No. PCT/US13/38794 is a continuation-in-part of application No. 12/042,452, filed on Mar. 5, 2008.
(60) Provisional application No. 61/640,247, filed on Apr. 30, 2012.
(60) Provisional application No. 60/904,938, filed on Mar. 5, 2007.

(51) Int. Cl. A23K 1/00; A23N 17/00

(52) U.S. Cl. CPC A23K 1/006; A23N 17/001; A23K 1/002
USPC 426/2; 99/516

(57) ABSTRACT

Processes for producing animal feeds from biomasses are disclosed. Uses of the processed biomasses and, optionally industrial co-products, as animal feeds are also disclosed.

### CROSS-REFERENCE TO RELATED APPLICATIONS

This application is a continuation of pending International Application No. PCT/US13/38794 filed Apr. 30, 2013, which itself claims priority to U.S. Provisional Patent Application No. 61/640,247, filed Apr. 30, 2012, each of the contents of the entirety of which are incorporated by this reference. This application is also a continuation-in-part of pending U.S. application Ser. No. 12/042,452 filed Mar. 5, 2008, which itself claims priority to U.S. Provisional Patent Application No. 60/904,938, filed Mar. 5, 2007, each of the contents of the entirety of which are incorporated by this reference.

### TECHNICAL FIELD

The present invention relates generally to animal feeds. More specifically, the present invention relates to methods of making lignocellulosic biomasses more digestible as an animal feed as well as processes for producing more nourishing animal feeds from biomasses.

### BACKGROUND

Coarse grains, such as corn, are fed to cattle and monogastric livestock (pigs, poultry) to provide energy, protein, and minerals. The starch in corn is readily metabolized by hydrolytic and enzymatic processes in the animal yielding organic acids and sugars suitable for absorption from the gastrointestinal tract. The digestive processes are highly evolved and energetically efficient when diets contain readily digested grains.

However, rising global demand for food and renewable energy places pressure on available grain stocks and, in particular, industrial processing results in a number of issues. For instance, there is a loss of energy from starch for livestock feeds and there is an additional production of grain dry milling coproducts, which provide ample supplies of protein for animals, but there is a deficiency in digestible energy.

Lignocellulosic biomasses such as corn stover, wheat straw, and bio-energy crops (e.g., switchgrass) comprise mainly cellulose, hemicelluloses, and lignin fractions with the largest fraction being cellulose. These biomasses primarily include carbohydrates which, in theory, could be used in combination with the protein-rich coproducts such as distillers grains to form balanced animal feed products.

However, converting these biomasses into usable carbohydrates is a challenge. The cellulose includes long chains of beta glucosidic residues having a high degree of processes crystallinity. Hemicellulose is an amorphous heteropolymer, and lignin is mainly aromatic polymers interspersed and linked among the cellulose and hemi-cellulose within the plant fiber. The cellulose and hemicellulose are partially broken down to a varying degree by enzymatic processes in the gastrointestinal tract of livestock, with ruminant species being more adapted to ferment such carbohydrate sources in the enlarged forestomach or rumen. However, a potentially digestible fiber content remains in these materials that is inaccessible to the animal due to the partial insolubility, crystalline nature, and lignification of such materials.

Certain methods exist to access the potential energy stored in these materials, and accumulation of biomass in an active area of research and commercial development. The agricultural residues or biomasses, such as corn stover or wheat straw, can be raked and baled to produce round or square bales. Such bales may be collected and the biomass stored therein may be ground into smaller particles. One method of treating such biomass is a batch-process. The batch-process includes grinding and loading the ground biomass into a container that can mix the ground biomass (such as a feed mixer wagon), where water may be added to uniformly wet the ground biomass. During such mixing, an inorganic hydrolyzing agent (such as calcium oxide powder) may be added to the wetted, ground biomass in order to thoroughly mix the inorganic hydrolyzing agent with the wetted, ground biomass. The resultant mixture may be discharged from the container into a bunker or plastic bag and anaerobically stored. However, such batch process requires considerable time, equipment, and labor.

Thus, a need exists to find ways to form animal feed products from biomasses that can substitute for the grain and starch in livestock rations. A need also exists for a way to enable lignocellulosics to be processed to enhance digestibility of the fiber contained therein which results in an improved source of energy available to the animal.

### SUMMARY

In each of its various embodiments, the present invention fulfills these needs and discloses improved methods of treating biomasses to make the carbohydrates therein more accessible for digestibility in animal feeds.

In one embodiment, a continuous process for converting biomass into a more digestible animal feed comprises comminuting biomass into smaller fractions and contacting the smaller fractions with a hydrolyzing agent and water at a moisture content of 25-55% at ambient temperature and ambient pressure, thus producing a treated biomass.

In a further embodiment, a continuous process for producing an animal feed comprises comminuting biomass into smaller fractions and contacting the smaller fractions with a slurry comprising an inorganic hydrolyzing agent and water, such that a moisture content of the contacted smaller fractions is between 25-55%, thus producing a treated biomass. The process further includes storing the treated biomass for at least 24 hours and feeding the stored biomass to an animal.

In another embodiment, a system for converting biomass into a more digestible animal feed includes a device for comminuting biomass into smaller fractions, a conveyer for moving the smaller fractions from the device, and means for spraying an aqueous solution comprising an inorganic hydrolyzing agent onto the smaller fractions on the conveyer.

### BRIEF DESCRIPTION OF THE DRAWINGS

FIG. 1 illustrates one embodiment of a system used to place a hydrolyzing agent in contact with a biomass of the present invention.

FIG. 2 illustrates an embodiment of one configuration for spray bars used to place a hydrolyzing agent in contact with a biomass of the present invention.

### DETAILED DESCRIPTION

Work on preparing more digestible animal feeds has continued. US Patent Application Publication 2008220125 discloses methods of making more digestible animal feeds. The inventors have discovered a process for treating fiber-containing lignocellulosic biomass to increase the digestibility of the lignocellulosic fraction, thus providing animal feeds for ruminants and monogastric animals. The process may be operated continuously and treat a high capacity of biomass.

The present invention helps promote the sustainability of agriculture. Since the process of the present invention produces an animal feed product including treated biomass and an agricultural co-product that can substitute for corn and forages such as untreated corn stover, the present invention helps alleviate concerns with the carbon intensity of ethanol production from corn. Further, the present invention is less energy intensive than known biomass processing techniques and since the treated biomass has liquid holding capacity, the present invention is able to utilize liquid feed ingredients in their wet form alleviating the energy intensive drying process.

In one embodiment, the present invention discloses processes for producing animal feeds from improved lignocellulosic biomass. In another embodiment, the process of the present invention may be combined with coproducts of agricultural processing.

In one embodiment, the present invention describes a continuous process for treating biomass which comprises size reducing the biomass and contacting the biomass with a hydrolyzing agent. The processes of the present invention minimize equipment requirements and labor per ton of biomass treated, thus, resulting in a lower processing cost. The continuous process also produces a consistent and uniform product.

In one embodiment, a process for converting biomass into a more digestible animal feed comprises comminuting biomass into smaller fractions and contacting the smaller fractions with a hydrolyzing agent at a moisture content of 25-55% at ambient temperature and ambient pressure, thus producing a treated biomass.

In an embodiment, a continuous process for converting biomass into a more digestible animal feed comprises comminuting biomass into smaller fractions and contacting the smaller fractions with a hydrolyzing agent and water at a moisture content of 25-55% at ambient temperature and ambient pressure, thus producing a treated biomass.

The treated biomass may be stored for at least 24 hours and may be stored aerobically. Comminuting the biomass may comprise grinding, shearing, or grinding and shearing the biomass. The contacting of the biomass with the hydrolyzing agent may occur in a device that comminutes the biomass. The moisture content may be between 45-55%. The hydrolyzing agent may be an inorganic hydrolyzing agent selected from the group comprising an oxide, a hydroxide, a peroxide, a carbonate, a bicarbonate, a percarbonate, calcium oxide, calcium hydroxide, sodium hydroxide, potassium hydroxide, magnesium oxide, magnesium hydroxide, lime, sodium carbonate, sodium bicarbonate, sodium percarbonate, potassium carbonate, potassium bicarbonate, potassium percarbonate, and combinations of any thereof.

The continuous process may also include placing the biomass in a device for comminuting the biomass into the smaller fractions and removing the smaller fractions from the device for comminuting the biomass with a carrier device for moving the smaller fractions. The smaller fractions are sprayed with the aqueous solution on the carrier device. The continuous process may further include mixing an agricultural co-product with the treated biomass.

The biomass may be selected from the group consisting of a biofuel crop, a bioenergy crop, a perennial grass, crop residues, food waste, algal mass, sugarcane, corn cobs, corn husks, corn stover, wheat straw, wheat chaff, switch grass, miscanthus, corn fiber, soy fiber, soy hulls, soybean straw, cocoa hulls, distiller dry grains, distillers dry grains with solubles, barley straw, rice straw, flax hulls, wheat germ meal, corn germ meal, cottonseed hulls, cottonseed trash, cereal straw, sorghum, grasses, and combinations of any thereof.

The continuous process may also include separating the smaller fractions into a fine fraction and a coarse fraction. Separating the smaller fractions may comprise passing the smaller fractions over at least one opening in a surface, collecting the smaller fractions passing through the at least one opening, thus producing the fine fraction, and collecting the smaller fractions that do not pass through the at least one opening, thus producing the coarse fraction.

The fine fraction has improved liquid holding characteristics, improved digestibility, or a combination thereof as compared to the smaller fractions.

Separating the smaller fractions may comprise passing the smaller fractions through a stream of air and may occur after the smaller fractions are contacted with the hydrolyzing agent.

The continuous process may also include feeding the fine fraction to a first animal and feeding the coarse fraction to a second animal that is different than the first animal. The first animal may be a beef cow. The second animal may be a dairy cow or a swine.

The continuous process may be able to process at least 350 kilograms of the biomass per minute, or may be able to process at least 450 kilograms of the biomass per minute.

The continuous process may also include densifying the treated biomass and the treated biomass may be mixed with a liquid feed ingredient before the densifying. Densifying the treated biomass may include an act selected from the group consisting of pelleting the treated biomass, briquetting the treated biomass, and a combination thereof.

The hydrolyzing agent may comprise a mineral selected from the group consisting of calcium, sodium, potassium, magnesium, and combinations of any thereof. In such instances, the process may further comprise feeding the treated biomass to an animal and placing an amount of the mineral in the aqueous solution sprayed onto the smaller fractions such that the amount of mineral consumed by the animal corresponds to a dietary guideline of the animal.

Contacting the small fractions with the aqueous solution may comprise spraying the small fractions with the aqueous solution. Comminuting the biomass into the smaller fractions may occur in a combine. The hydrolyzing agent and the water may be in an aqueous solution or the hydrolyzing agent may be a solid. The hydrolyzing agent may be present at an amount of about 2% to about 10% by weight.

A continuous process for producing an animal feed comprises comminuting biomass into smaller fractions and contacting the smaller fractions with a slurry comprising an inorganic hydrolyzing agent and water, such that a moisture content of the contacted smaller fractions is between 25-55%, thus producing a treated biomass. The process further includes storing the treated biomass for at least 24 hours and feeding the stored biomass to an animal.

The biomass may be corn stover. Comminuting the biomass may comprise grinding, shredding, or grinding and shredding the biomass. The process may further comprise moving the smaller fractions from a device for comminuting the biomass and onto a device configured for contacting the smaller fractions with the slurry.

Contacting the small fractions with the slurry may comprise pumping the slurry from a container to a means for spraying the slurry on the smaller fractions and spraying the slurry on the smaller fractions.

The process may further comprise collecting the biomass from a field. Collecting the biomass may comprise raking and baling the biomass from the field or may comprise baling the biomass from a combine.

The inorganic hydrolyzing agent may be selected from the group comprising an oxide, a hydroxide, a carbonate, a bicarbonate, a percarbonate, calcium oxide, calcium hydroxide, sodium hydroxide, potassium hydroxide, magnesium oxide, magnesium hydroxide, lime, sodium carbonate, sodium bicarbonate, sodium percarbonate, potassium carbonate, potassium bicarbonate, potassium percarbonate, and combinations of any thereof.

The biomass may be stored aerobically or anaerobically.

The continuous process may further comprise mixing an acidic, agricultural co-product with the treated biomass. The acidic, agricultural co-product may be liquid.

The inorganic hydrolyzing agent may be lime. The moisture content may be between 45-55%. The process may be carried out at ambient pressure and ambient temperature. The process may be able to process at least 350 kilograms of the corn stover per minute or able to process at least 450 kilograms of the biomass per minute.

The process may further comprise separating the smaller fractions into a fine fraction and a coarse fraction.

In an embodiment, a system for converting biomass into a more digestible animal feed includes a device for comminuting biomass into smaller fractions, a conveyer for moving the smaller fractions from the device, and means for spraying an aqueous solution comprising an inorganic hydrolyzing agent onto the smaller fractions on the conveyer. The system may further comprise an apparatus for separating the smaller fractions into a coarse fraction and a fine fraction.

In another embodiment, a continuous process for producing an animal feed comprises comminuting biomass into smaller fractions and contacting the smaller fractions with a slurry comprising an inorganic hydrolyzing agent and water, such that a moisture content of the contacted smaller fractions is between 25-55%, thus producing a treated biomass. The process also includes storing the treated biomass for at least 24 hours and feeding the stored biomass to an animal.

In yet an additional embodiment, a process for producing an animal feed from corn stover includes comminuting the corn stover to smaller portions and placing an inorganic hydrolyzing agent in contact with the smaller portions and water such that a moisture content of the smaller portions and the inorganic hydrolyzing agent is between 25-55%, thus producing treated corn stover. The process further comprises storing the treated corn stover for at least 24 hours and feeding the stored, treated corn stover to a ruminant.

In another embodiment, the moisture content of the biomass is brought up to at least 35% and in another embodiment, the moisture content is brought up to about 50% by adding water to the biomass. The hydrolyzing agent may be suspended in the water to form a slurry that can be placed in contact with the biomass. Thus, the moisture content of the biomass is adjusted at the same time the hydrolyzing agent is placed in contact with the biomass. The water and/or hydrolyzing agent may be applied to the biomass after the biomass is ground, thus resulting in the continuous grinding and treating of the biomass.

In another embodiment, the process of the present invention results in treated biomasses that are uniformly improved and stable during storage. The processed biomass may be stored aerobically without decomposition and surprisingly, such aerobic storage actually improves the feed value.

The treated biomasses may be combined with agricultural co-products, such as co-products from fermentation processes including, but not limited to, distillers grains, corn gluten feed, corn distillers solubles, condensed fermented corn extractives, and lysine fermentation solubles. The co-product may originate from food preparation, an ethanol fermentation or a biofuel production process. The combination of the treated biomasses with such co-products can act as a substitute for grain feeds, where the combination has similar and potentially better conversion of the combination to meat and milk products as compared to the grain products.

The agricultural co-products contain protein, vitamins, and minerals that are beneficial to animals. Care needs to be taken to ensure that certain nutrients are not fed in excess which can impair animal performance. For instance, overfeeding of sulfur may result in hydrogen sulfide poisoning in cattle, overfeeding of nitrogen and/or phosphorus can have negative environmental impacts, and overfeeding of sodium and/or potassium can increase risk of soil salinization. Thus, when combined with agricultural co-products, the improved biomasses of the present invention may help create a more favorable balance of nutrients, thus improving the overall utilization of an animal feed blend.

In one embodiment, a process for producing an improved biomass includes contacting a biomass source with a hydrolyzing agent for a time sufficient to increase the digestibility of the biomass source by at least about 10% or a time sufficient to solubilize at least 15% of edible fiber in the biomass source. During the process, the biomass source has a moisture content of 50% or less while being contacted with the hydrolyzing agent, or a moisture content of about 50% in another embodiment.

In one embodiment, the process of the present invention is carried out in a continuous operation. Contact of the hydrolyzing agent with the biomass is in a close association with the physical process used to reduce the size of the biomass in order to make the process more efficient. For instance, the biomass may be size reduced, such as by grinding, shearing and/or shredding, and subsequently contacted with the hydrolyzing agent, the biomass may be contacted with the hydrolyzing agent and subsequently size reduced, or the biomass may be simultaneously size reduced and contacted with the hydrolyzing agent. The close physical proximity of the size reduction process and contacting the biomass with hydrolyzing agent process reduces the number of mechanical operations required for biomass processing.

In another embodiment, the agricultural co-product may be added to the biomass in close physical proximity to the size reduction process and/or contact of the biomass with the hydrolyzing agent process to achieve efficiency. After reducing the size of the biomass, placing the biomass in contact with the hydrolyzing agent, mixing an agricultural co-product with the biomass, or any combination thereof, the biomass may be stored anaerobically or aerobically before being fed to an animal.

In an additional embodiment, the biomass is contacted with the hydrolyzing agent after the biomass is size reduced, such as less than 60 seconds after size reducing. Depending on the hydrolyzing agent used, the pH of water extracted from the biomass that has been contacted with the hydrolyzing agent may exceed 9 or may exceed 10.

The hydrolyzing agent may be selected from the group including a pH modifying agent, an oxidizing agent, or a combination thereof. The hydrolyzing agent may be present at concentrations of between about 2% to about 10%, or from about 2.5% to about 8%. The hydrolyzing agent may be an inorganic hydrolyzing agent selected from the group comprising an oxide, a hydroxide, a peroxide, a carbonate, a bicarbonate, a percarbonate, calcium oxide, calcium hydroxide, sodium hydroxide, potassium hydroxide, magnesium oxide, magnesium hydroxide, lime, sodium carbonate, sodium bicarbonate, sodium percarbonate, potassium carbonate, potassium bicarbonate, potassium percarbonate, or combinations of any thereof. The hydrolyzing agent may be selected or formulated to achieve an improved nourishment of an animal for specific minerals, to reduce environmental impact caused by feeding any one of the minerals, and/or to improve the efficacy of treating a specific lignocellulosic material in the biomass.

In another embodiment, the hydrolyzing agent may be a mixed base formulation comprising two or more of the hydrolyzing agents disclosed herein. Sometimes use of a single base may encounter limitations such as possible salination of soils, cost of the hydrolyzing agent, activity of the hydrolyzing agent, mineral contribution to final animal diet, or other limitations.

In yet a further embodiment, a surfactant may be used in combination with the hydrolyzing agent to treat the biomass. Such surfactant would be selected to function at the pH of the selected hydrolyzing agent and/or function as a phase transfer catalyst. The surfactant may include a quarternary ammonium and/or tertiary sulfonium compound such as betaine and/or 3-dimethylsulfoniopropionate (DMSP). The surfactant may also be the a composition including lecithin, sodium lactate, polysorbate 80, lactic acid, soy fatty acids, and ethyl lactate. The surfactant may be applied to the biomass in sequence with the hydrolyzing agent within the process of the present invention, or may be mixed with the hydrolyzing agent such that the surfactant and the hydrolyzing agent are placed in contact with the biomass at the same time, thus improving the handling characteristics and suspension of the hydrolyzing agent in an aqueous solution as well as improving the efficacy of the hydrolyzing agent for solubilizing materials within the biomass.

In yet another embodiment, the biomass may be contacted with an enzyme as the hydrolyzing agent or in combination with the hydrolyzing agent. Enzymes that may be used include, without limitation, cellulases, hemicellulases, xylanases, esterases, proteases, and combinations of any thereof. The enzymes could also come from a living organism and/or an extract having enzymatic activity. The enzymes may be placed in contact with the biomass for a time sufficient to solubilize carbohydrates from the fiber source within the biomass. The enzyme may be contacted with the biomass before, after, or simultaneously with placing the hydrolyzing agent, phase transfer catalyst, and/or surfactant in contact with the biomass. The enzyme may be utilized at a temperature of at least 20° C. or at a range of from 0° C. to 80° C. In another embodiment, the processed biomass may be stored aerobically or anaerobically for a period of up to 10 days before further processing and being fed to an animal.

In various embodiments, the biomass is selected from the group consisting of a biofuel crop, a bioenergy crop, a perennial grass, crop residues, food waste, corn stover, corn cobs, corn husks, corn stover, material other than grain (MOG), corn silage, wheat straw, wheat chaff, switch grass, miscanthus, corn fiber, soy fiber, soy hulls, soybean straw, cocoa hulls, distiller dry grains, distillers dry grains with solubles, algae biomass, barley straw, rice straw, flax hulls, wheat germ meal, corn germ meal, cottonseed hulls, cottonseed trash, cereal straw, sorghum, sorghum residue, expressed sorghum residue, sugarcane, grasses, or combinations of any thereof. The treated biomasses of the present invention may also be mixed with a feed ingredient, liquid or solid, to improve the nutritional quality of an animal feed. The feed ingredients may be selected from the group consisting of condensed fermented extractives, condensed distillers solubles, plant-based soap stocks, molasses, corn syrup, fermentation solubles, fermentation liquors, fermentation biomass, amino acids, algal mass, glycerin, fats, oils, lecithin, and combinations of any thereof. The feed ingredient may be in dry or solid form, and may be used to form wet or dry feed blends with a mixture of insoluble and soluble carbohydrates formed by the fiber hydrolysis step or steps.

In yet a further embodiment, a process for producing a more digestible biomass includes contacting a biomass with a fiber hydrolyzing agent for a time sufficient to solubilize a first portion of carbohydrates from lignocellulosic material in the biomass and optionally contacting the biomass with an enzyme for a time sufficient to solubilize a second portion of carbohydrates from the lignocellulosic material in the biomass. The contacted or treated biomass having an insoluble fiber fraction and a soluble carbohydrate fraction can be fed to an animal “as is,” that is without further treatment or in another embodiment, may be dried. Such process is advantageous in that it can be practiced at ambient temperature and ambient pressure.

In another embodiment, a biomass may be contacted with the enzyme and the hydrolyzing agent in any order, that is by contacting with the enzyme first, the hydrolyzing agent first, or the biomass can be contacted with the enzyme and the hydrolyzing agent simultaneously. Further, a surfactant as described herein can be added to this process as well.

In yet an additional embodiment, the biomass is reduced to particles or sizes having a longest mean size, or dimension, of about 6 mm to about 76 mm for being placed in contact with the hydrolyzing agent and/or enzyme. The particle size may also be about 50 mm in its longest dimension.

In a further embodiment, a process for treating a biomass comprises reducing a particle size of a biomass, contacting the reduced particle size biomass with a hydrolyzing agent, and storing the reduced particle size biomass that has been contacted with the hydrolyzing agent. The biomass may be stored for between about 24 hours and about 240 hours. The process may be continuous and may be carried out at ambient temperature and ambient pressure. Contact with the hydrolyzing agent solubilizes a first portion of carbohydrates from the biomass. Optionally, the biomass may also be contacted with an enzyme to solubilize a second portion of carbohydrates from the biomass. The biomass that has been contacted with the hydrolyzing agent and/or the enzyme may be compressed (i.e., densified) and stored anaerobically in a plastic bag, bunker, or silo, or may be stored aerobically without being compressed. The pH of the contacted biomass may be adjusted such as by addition of ethanol, biofuel co-products, inorganic acids such as sulfuric or phosphoric acids, or organic acids such as formic, acetic, lactic or citric acid. Sources or enzymes or organic acids may also be microbial mass retaining biologic activity, live microbial additives, and microbial inoculants.

In one embodiment, animal feeds produced by the processes described herein are also disclosed. Such animal feeds include an insoluble fiber fraction and a soluble carbohydrate fraction, each of which are derived from the treated biomass. The animal feed may optionally include supplemental ingredients to provide improved nourishment for the animal. The animal feed may include insoluble fiber fractions having a longest dimension of between about 0.5 mm to about 76 mm, or be about 25 mm at its longest dimension. The animal feed may also include at least about 45% of soluble carbohydrates as a percentage of the total carbohydrates in the treated biomass. The animal feed may also include an enzyme as described herein.

In another embodiment, a more dense animal feed produced by the processes of the present invention may be made by reducing the biomass to a mean particle size of between about 0.5 mm and about 12 mm prior to or after contact with the hydrolyzing agent and/or enzyme. Water may also be added to the biomass and mixed as free water or steam, and may be added during the process of treating the biomass or during a densification process after treatment, such as pelleting or briquetting. In another embodiment, an additional feed ingredient, liquid or solid, may be mixed with the treated biomass and be densified along with the treated biomass.

In one embodiment, the moisture content of the biomass during the process of treating the biomass may be controlled in order to elicit the most efficient solublization of the carbohydrates possible. The water may be added to the biomass before being contacted with the hydrolyzing agent, at the same time the hydrolyzing agent is contacted with the biomass, or after the biomass is contacted with hydrolyzing agent.

In an additional embodiment, the treated biomass may be wet or may be dried depending on the desired use. If dried, the moisture content may be 10-14% moisture.

In yet a further embodiment, the biomass that has been contacted with the hydrolyzing agent or the biomass before treatment with the hydrolyzing agent may by separated on the basis of size, density, and/or liquid holding capacity. Physical separation of the treated biomass may be effectuated by air classification, use of a screen, use of a trommel, or other means and may enable the formation of optimally configured wet and/or dry animal feed blends derived from one single treatment process. Such physical separation may produce a smaller, fine fraction and a larger, coarse fraction.

The separation of the biomass into the fine fraction and coarse fraction may also have added benefits of being handles as the fine fraction may be easier to move with conveyers, be placed into drum dryers, or other. The fine fraction and coarse fraction may each also have nutritional benefits that can be fed to different animals based on animal performance, animal species, stage of production of the animal, and/or nutritional requirement of the animal. For instance, the coarse fraction may be fed to growing dairy heifers and the fine fraction may be fed to lactating animals with more constraints on fiber intake.

In one embodiment, a process of treating biomass of the present invention comprises applying a calcium hydroxide slurry solution with calcium oxide added at 5% of the dry matter of biomass with a quantity of water such that the treated biomass has a moisture content of about 50%. The present invention uses a moisture content less than that of other processes for treating biomass and, thus, allows for less water usage. Further, the amount of water used in the present invention allows for sufficient heat absorbing capacity of the exothermic reaction that occurs when calcium oxide reacts with the water.

### EXAMPLES

The following exemplary, non-limiting examples are provided to further describe the embodiments presented herein. Those having ordinary skill in the art will appreciate that variations of these Examples are possible within the scope of the invention.

### Example 1

### Integrated Size Reduction and Contacting Process

A series of studies were performed in order to evaluate equipment and methods for simultaneous size reduction and treatment of biomass. Ton quantities of corn stover were used in these studies and a high-capacity process for treating biomass and producing an animal feed was developed.

A continuous shearing and contacting system was designed to operate under conditions typical for commercial-scale processing of biomass. The shearing/contacting system was operated under conditions of variable feedstock quality and the feedstock included observable debris and contaminants as would be expected from biomass collected from the field.

Corn residue including stalks, leaves, husk, and cob with grain removed (i.e., corn stover) was used as the lignocellulosic source or biomass. The corn stover was sheared using a commercially available tub grinder (Haybuster Model 1150) and the sheared corn stover was contacted with an inorganic hydrolyzing agent on the discharge belt of the tub grinder.

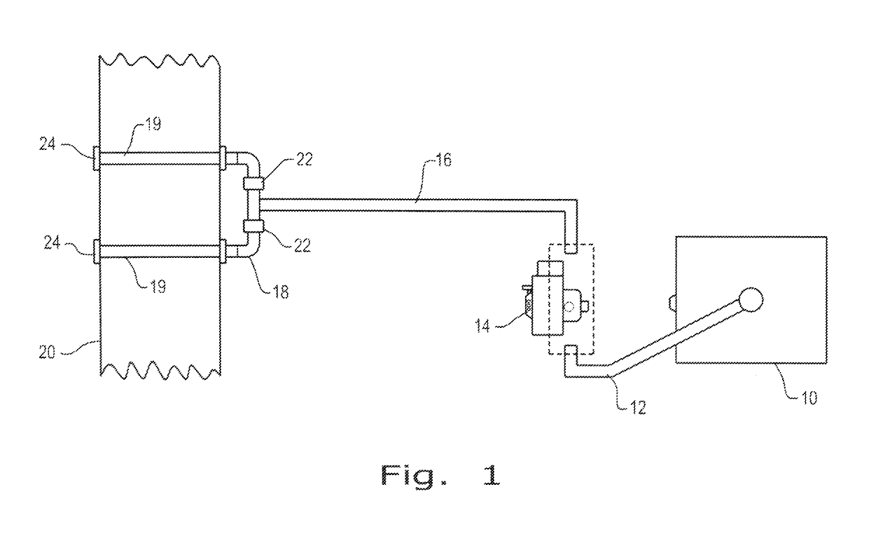

The equipment used to apply the inorganic hydrolyzing agent included an infeed system to meter the amount of solution added and spray bars configured with nozzles designed for uniform wetting of the biomass. A diagram of the system used to apply the hydrolyzing agent to the biomass is shown on FIG. 1. The system includes a container 10 which includes the hydrolyzing agent, a hose 12 for removing the hydrolyzing agent from the container 10, a pump 14 for pumping the hydrolyzing agent and water, a hose 16 for transporting the hydrolyzing agent and water for application to the biomass such as corn stover, a U-shaped manifold 18 for placing the hydrolyzing agent and water in contact with the biomass, and a conveyer belt 20 for moving the corn stover from the grinder (not shown).

The container 10 may be a mix tank with a mixing device for agitating the hydrolyzing agent in the water to keep such slurry uniform in consistency.

The U-shaped manifold 18 includes two spray bars 19 which each spray the hydrolyzing agent and water on the biomass. The spray bars 19 were mounted transverse to the conveyer belt 20 as the biomass is moved past the U-shaped manifold 18 on the conveyer belt 20. One spray bar included eight, 6.4 mm holes at the greatest diameter of the hole and the holes were spaced about 76 mm apart. The other spray bar included nine, 6.4 mm holes at the greatest diameter of the hole and the holes were spaced about 76 mm apart. The locations of the holes on the two spray bars 19 were staggered such that when the two spray bars 19 were operated in tandem, the hydrolyzing agent was applied to the corn stover on the conveyer belt 20 at distances of about 37 mm across the 760 mm conveyer belt 20 width. A dual strainer mechanism (not shown) was integrated into the system to strain out any debris from the hydrolyzing agent and water and enabled the system to be cleaned, even while the system was processing at constant capacity.

The spray bars 19 have precisely sized and located holes which enable the ground biomass to be properly and completely wetted with the slurry of the hydrolyzing agent in the water for a fast and complete chemical reaction.

A second U-shaped manifold 18 was constructed and had similarly spaced holes that were 9.5 mm in diameter. The second U-shaped manifold with the larger holes operated in a similar fashion to the first U-shaped manifold and the two U-shaped manifolds operated adjacent to each other. The discharge holes were drilled into the bottom, i.e., the portion that faced the conveyer belt 20, of the spray bars 19 and were angled vertically downward to facilitate the hydrolyzing agent and water contacting the biomass with a penetrating stream. The hydrolyzing agent and water were applied to the biomass at a pressure sufficient to cause penetration of the hydrolyzing agent to a full depth of the biomass on the conveyer belt 20. By using two sets of U-shaped manifolds 18, the capacity of the amount of biomass can be increased, but it will be apparent by one of ordinary skill in the art that one U-shaped manifold of more than two could be used. Valves 22 were added to the U-shaped manifold 18 in line with each spray bar 19 to improve control of the hydrolyzing agent flow rate and to enable the hydrolyzing agent application rate for different speeds of the conveyer belt 20 and amounts and sizes of the biomass on the conveyer belt 20. A clean out valve 24 was also present on each spray bar 19 to enable cleaning, as needed, during the process.

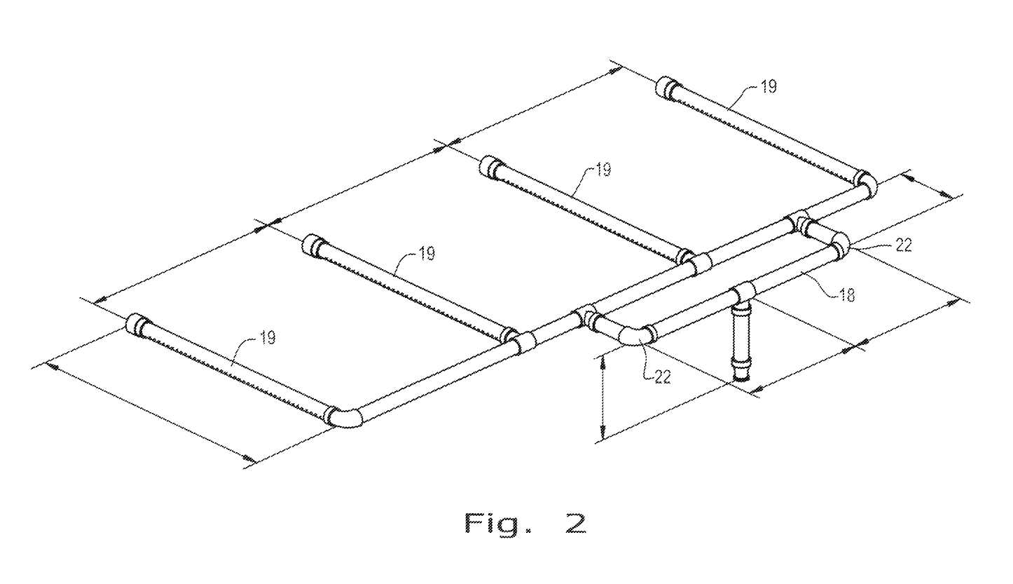

The U-shaped manifold was fitted to a discharge conveyer belt 20 of the tub grinder (not shown). The tub grinder was fitted with 76 mm (3 inch) round hole screens. Using this setup, 75 corn stover bales weighing about 545 kg each were ground and about 7000 gallons of hydrolyzing agent (a lime suspension) was applied to the ground corn stover in 80 minutes without stopping. Such setup enabled 10 metric tons of dry corn stover to be treated per hour with the hydrolyzing agent. In yet a further embodiment, the hose 16 for transporting the hydrolyzing agent and water, U-shaped manifold 18, and valves 22 may be configured with four spray bars 19 as illustrated in FIG. 2.

In another embodiment, the effects of grinding rate on contacting of the corn stover with the hydrolyzing agent were evaluated. The grinding rate (kg/hr) by the tub grinder was altered by changing the screen size in the grinder where screen sizes of 76 mm, 127 mm, and 178 mm were evaluated. The hydrolyzing agent (suspended lime) was applied as a hydrated suspension to achieve an application rate of 5% lime on a weight:weight dry matter basis. Such evaluation also allowed the determination of whether more fine grinding would improve contacting the corn stover with the hydrolyzing agent. Ten bales of corn stover were ground for each screen size and the hydrolyzing agent (lime suspension) was applied using the system of FIG. 1. For each screen size evaluated, five bales of stover were ground but not treated with the hydrolyzing agent to serve as a baseline or control.

Samples of control corn stover and corn stover treated with hydrolyzing agent were collected immediately after being discharged from the conveyer belt of the tub grinder and the pH was measured by extracting the corn stover with distilled water and measuring the pH of the extracted fluid. This enabled the ability to ascertain whether the corn stover had been contacted with the hydrolyzing agent, as evidenced by an increase in pH. The results are presented in Table 1 and indicate that the application device was able to successfully apply the hydrolyzing agent to the corn stover as indicated by the increase in the pH. The application device was able to successfully apply hydrolyzing agent at 11.5 to 27 metric tons of dry corn stover per hour.

TABLE 1
Characteristics of corn stover contacted with hydrolyzing agent
(suspended lime) in an integrated shearing-processing system.

| | | | | Shearing | |
|---|---|---|---|---|---|
| | Stover | | | results | Shearing results |
| Screen | Initial | | | Capacity, | Calculated dry |
| Mm (in) | moisture % | pH before | pH after | kg/minute | Mt/hour |
| 76 (3) | 14.8 | 9.93 | 12.14 | 453 | 11.57 |
| 127 (5) | 14.2 | 10.62 | 12.18 | 446 | 11.48 |
| 178 (7) | 11.9 | 10.66 | 12.25 | 1017 | 26.99 |

Samples of processed stover were retained and stored anaerobically for 2 weeks and analyzed for edible fiber content and digestibility of dry weight in order to see if the feed value of the treated corn stover increased. The edible fiber content was measured by incubating samples in a neutral buffer solution and digestibility of dry matter was determined by incubating samples for 48 hours in a buffered solution of ruminal fluid containing a mixed culture of rumen microbes. Results are presented in Table 2.

TABLE 2
Characteristics of corn stover contacted with lime hydrolyzing
agent in a continuous shearing-contacting process.
Characteristics of Corn Stover Contacted with Lime in a Continuous Shearing - Contacting Process

| | | Insoluble Edible | | | | Improvement | |
|---|---|---|---|---|---|---|---|
| Tub Grinder | | Fiber, g/100 g of | | Digestibility of | | Fiber | |
| Screen, mm | MPS¹, | dry weight | | stover dry weight, % | | Solubilized, | DMD¹ |
| (in) | mm | Control | Contacted | Control | Contacted | g/100 g | g/100 g |
| 178 (7″) | 18.9 | 78.6 | 68.2 | 65.4 | 69.2 | 10.3 | 3.7 |
| 127 (5″) | 11.7 | 72.3 | 63.5 | 63.5 | 72.0 | 8.8 | 8.5 |
| 76 (3″) | 11.8 | 78.6 | 63.4 | 60.1 | 71.6 | 15.2 | 11.5 |

Particle Separation² (across grinder screen size)

| | | | | | | |
|---|---|---|---|---|---|---|
| Large (top) | 83.7 | 69.9 | 65.7 | 71.7 | 13.8 | 6.0 |
| Intermediate (middle) | 74.5 | 68.1 | 60.3 | 65.0 | 6.4 | 4.7 |
| Small (bottom) | 72.4 | 54.9 | 63.0 | 76.3 | 17.5 | 13.3 |

¹MPS = geometric mean particle size, DMD = dry matter digestion
²Separated by dry sieving in laboratory, Top Screen = >19 mm, Middle Screen = 8 mm to 19 mm, Bottom Screen <8 mm.

The data from this evaluation show that contacting the corn stover with the hydrolyzing agent resulted in a solublization of 9 to 15 grams of edible fiber per 100 grams of fiber from the corn stover. There appeared to be an advantage of using the 76 mm screen in the tub grinder because there was an improved solublization of edible fiber and improved digestibility compared to the corn stover ground in the 127 mm and 178 mm screens. Such results suggest that more efficiency of the process may be achieved if the particle size of the biomass is reduced, which is supported by the measured improvements in dry matter digestion for small particles contacted with the hydrolyzing agent as compared to the larger size particles as shown in Table 2.

Collectively, this Example demonstrates that the continuous shearing-contacting system can be operated at constant and high capacity in order to effectuate contacting a biomass with a hydrolyzing agent in a manner that was able to solubilize at least 8 grams of fiber per 100 grams of biomass and even solubilize up to 15 grams of fiber per 100 grams of biomass, as well as improving the digestibility of the dry matter.

### Example 2

### Feed Value of Biomass Produced by the Integrated Shearing-Contacting Process

Corn stover treated during the large-scale trials of Example 1 was subjected to studies to evaluate whether contacting with hydrolyzing agent (lime) would improve the feed value of the corn stover. The feed value is improved by increasing the solubility of edible fiber under the assumption that solubilized fiber is more susceptible to enzymatic hydrolysis in an aqueous environment, such as a ruminant forestomach. Also, since lignin is indigestible and reducing the amount of lignin or lignin's association with fiber can improve the nourishment value of treated feed. Calcium is an essential mineral and is often added in some form to a daily ration of feed fed to livestock. Thus, increasing the calcium content of biomass would be a means of improving the value of the treated biomass as an animal feed. Increasing the pH of a biomass would also be an improvement, especially when the biomass is subsequently fed in diets that contain acidic foodstuffs, such as those obtained as by-products of agricultural processing. Examples of acidic foodstuffs include distillers dried grains, condensed distillers solubles, and condensed fermented corn extractives. Mixing of an alkaline feedstuff into acidic feed rations could possibly improve pH balance of the feed ration and the gastrointestinal tract upon ingestion of the feed by the animal, thus causing an improvement in the digestibility of the feed ration.

The feed value of the treated corn stover of Example 1 was assessed by anaerobically storing samples of the treated corn stover of Example 1 for 10 days, and assaying the stored samples for pH and concentrations of edible fiber, lignin, and calcium. Untreated stover was also assayed as a control. As shown in Table 3, treating the corn stover with the hydrolyzing agent resulted in a substantial elevation of pH and it solubilized a large amount of edible fiber, particularly for the corn stover processed using the 76 mm or 127 mm screens in the grinder. Also, the lignin content of the treated corn stover decreased for the more finely sheared stover, but increased for the more coarsely sheared corn stover. The better characteristics of the more finely sheared stover may be attributable to the fact that a smaller concentration of the hydrolyzing agent contacted the coarsely sheared stover as evidenced by the lower calcium concentration and lower pH values of the coarser corn stover as compared to the more finely sheared corn stover.

TABLE 3
Characteristics of biomass treated with a hydrolyzing agent in a continuous shearing process.

| | | Dry | Edible fiber, | Lignin, | Calcium, | |
|---|---|---|---|---|---|---|
| | Moisture, | Weight, | g/100 g of dry | % of dry | % of | |
| | % | % | weight | weight | dry weight | pH |
| 76 mm screen (3″) | | | | | | |
| Pre-treatment mean | 8.2 | 91.8 | 84.7 | 6.3 | 0.29 | 7.60 |
| standard deviation | 4.9 | 4.9 | 3.3 | 1.8 | 0.07 | 0.40 |
| Post-treatment mean - lime treated | 58.6 | 41.4 | 65.5 | 3.7 | 5.42 | 11.62 |
| standard deviation | 8.8 | 8.8 | 5.0 | 0.4 | 1.80 | 0.71 |
| Edible fiber solubilized, g/100 g of DM | | | 19.2 | | | |
| 127 mm screen (5″) | | | | | | |
| Pre-treatment mean | 5.6 | 94.4 | 84.5 | 5.2 | 0.30 | 7.10 |
| standard deviation | 0.4 | 0.4 | 1.3 | 1.2 | 0.01 | 0.07 |
| Post-treatment mean - lime treated | 63.7 | 36.3 | 63.4 | 7.1 | 6.74 | 11.71 |
| standard deviation | 5.3 | 5.3 | 3.3 | 5.1 | 2.45 | 0.99 |
| Edible fiber solubilized, g/100 g of DM | | | 21.1 | | | |
| 178 mm screen (7″) | | | | | | |
| Pre-treatment mean | 4.0 | 96.0 | 80.6 | 4.5 | 0.24 | 7.24 |
| standard deviation | 1.1 | 1.1 | 13.1 | 1.5 | 0.03 | 0.26 |
| Post-treatment mean - lime treated | 47.0 | 53.0 | 73.8 | 5.6 | 2.32 | 9.30 |
| standard deviation | 3.4 | 3.4 | 1.9 | 1.0 | 0.40 | 0.27 |
| Edible fiber solubilized, g/100 g of DM | | | 6.8 | | | |

The results of this study demonstrated that a continuous shearing-contacting process is useful for increasing the pH, solubilizing the edible fiber content of treated biomass, and possibly for decreasing lignin content. In one embodiment, the biomass is sheared in the tub grinder using a screen size of 127 mm or less in order to improve the contacting of the hydrolyzing agent with the biomass. Further, the use of lime as the hydrolyzing agent increased the amount of calcium, which may also be an added benefit, and the increased pH may be particularly helpful when the treated biomass is mixed with an acidic feedstuff.

### Example 3

### Aerobic Storage of Treated Biomass

Animal feedstuffs are often prone to decomposition over time and more so when moisture contents are sufficient for growth of undesirable molds and yeasts, such as at moisture contents above about 12%. A common practice to prevent such decomposition is to compress and store high-moisture feedstuffs under low oxygen (i.e., anaerobic conditions or ensiling) to stabilize the stored feedstuffs and prevent microbial decomposition. For instance, whole plant corn may be harvested at moisture contents between 50 and 80%, sheared, and compressed into bunkers or plastic bags and later fed as “corn silage” to ruminant livestock. While this method helps decrease degradation of the feedstuff, additional costs are incurred for processing the biomasses in such manner. This study evaluated whether a biomass could be treated, not compressed, and stored aerobically in order produce feedstuffs more economically.

A lab-scale storage trial was conducted to determine whether continuously contacted and sheared biomass could be stored aerobically. Corn stover was continuously sheared and contacted with a hydrolyzing agent as described in Example 1 using calcium hydroxide (hydrated lime) as the hydrolyzing agent. The shearing was accomplished in the tub grinder using a 76 mm screen, and a solution of the lime and water as the hydrolyzing agent. The hydrolyzing agent was applied to the corn stover to achieve a target moisture of about 50%. After treatment, a 30 kg portion of the corn stove contacted with lime was collected and stored aerobically at about 22° C., without being compacted. Samples of the 30 kg portion being stored were collected at one, three, and 10 days and digestibility of dry matter was measured. The pH was also measured after day 10. Digestibility was measured by macerating and hand-scissoring the samples to emulate chewing by a dairy cow. The macerated samples were exposed to ruminal enzymes by incubation in the rumens of lactating dairy cows for 48 hours. The residual material was dried and digestion of dry matter was calculated. The results are presented in Table 4.

TABLE 4
Characteristics of continuously sheared
and contacted corn stover after
aerobic storage.

| | | | Rumen DM | Improvement in DM |
|---|---|---|---|---|
| Time | DM, % | pH | digestibility, % | digestibility (g/100 g) |
| At contacting | ~85 | 12.5 | n.m. | — |
| | (before) | (after) | | |
| 1 day storage | 50 | | 54 | — |
| 3 days storage | 49 | | 59 | 5 |
| 10 days storage | 49 | 9.2 | 68 | 14 |

The contacted corn stover was measured to have a moisture content of about 49%, but there was not any evidence of molding by visual appraisal. The pH of the treated corn stover was measured to be 12.5 right after being contacted with the hydrolyzing agent and was 9.2 after 10 days of storage. Rumen dry matter digestion increased by 14 units, from 54% to 68%, for one day of storage as compared to 10 days of storage. The results of this Example indicate that high-moisture biomass may be aerobically stored without decomposition and result in a biomass with an improved feed value that occurs from aerobic storage, as indicated by a 26% improvement in digestibility by 10 days of storage as compared to 1 day of storage.

### Example 4

### Mixed Base Treatment of Biomass

Animal feeds are often fortified with minerals that are essential for health, growth, or other productive functions. Ideally, the feed mixtures contain adequate, but not excessive amounts of minerals because feeding the minerals in excess can cause antagonism among minerals and reduced efficiency of mineral use and overfeeding some minerals may even cause metabolic upsets and possibly environmental damage.

In this Example, a study was performed to evaluate the ability of bases containing calcium, sodium, magnesium, and potassium (multiple minerals) as hydrolyzing agents could efficiently improve feed digestion and solublization of edible fiber, while provide nourishing compositions as compared to a single mineral. This Example used extrusion processing of the biomass and hydrolyzing agent as described in US Patent Application 2008022012, the contents of the entirety of which is incorporated by this reference, to treat the biomass with the hydrolyzing agent. Calcium oxide was applied as a dry powder to the corn stover and water was added during treatment, Calcium oxide and magnesium oxide were also mixed with water to form a slurry before being added to the corn stover. Where utilized, sodium hydroxide, potassium hydroxide, and ammonium hydroxide were added to slurries to form base mixtures and placed in contact with corn stover during the extrusion process. Water was added as needed to adjust the process conditions to achieve the desired moisture content. After treatment, samples were collected and assayed for nutrient characteristics and digestibility of dry matter after 48 hours of incubation in buffered rumen fluid.

The results of this Example are presented in Table 5. The hydroxide slurry did not appear as effective as the addition of dry oxide with 62 v. 74% digestibility of dry matter, respectively. When sodium and potassium hydroxide are compared with 3% calcium hydroxide, sodium and potassium appeared to provide benefits of increased solublization of edible fiber and increased dry matter digestion in relation to 5% calcium oxide or calcium hydroxide. Potassium appeared less effective than sodium on its effect of dry matter digestibility, however, there was a lot of variation and potassium hydroxide alone provided effects similar to sodium hydroxide relative to effects on edible fiber content. Ammonium hydroxide was less effective within mixtures as compared to sodium or potassium hydroxides. The high pH of the system would shift the equilibrium towards ammonia ion with evolution of ammonia gas, thus reducing the efficacy of treatment. At low concentrations and in an enclosed vessel, the dispersion of ammonia ion into the fibrous material of the biomass may be advantageous, particularly at low moisture content (less than 35% moisture) or with coarser materials that may be more difficult to process with a liquid hydrolyzing agent.

TABLE 5
Characteristics of biomass contacted with combinations of hydrolyzing agents.

| | Contacting agent | | | | Edible | | | | | | | |
|---|---|---|---|---|---|---|---|---|---|---|---|---|
| | application rate, % | | | Moisture | Fiber¹ | Solubilized | DMD¹ | change | Ca | Na | K | Mg |
| | Ca | NaOH | | % | grams | grams | % | units | % of dry weight | | | |
| Control | | | | 37.2 | 74.3 | — | 64 | — | 1.5 | 0.1 | 1.3 | 0.28 |
| NaOH | | 2.5 | | 39.0 | 63.0 | 11.3 | 84 | 22 | 1.1 | 2.8 | 1.3 | 0.27 |
| NaOH | | 5.0 | | 38.9 | 54.5 | 19.8 | 90 | 30 | 0.9 | 3.6 | 1.1 | 0.22 |
| CaO | 5.0 | | | 28.6 | 54.4 | 19.9 | 74 | 10 | 5.4 | 0.0 | 1.1 | 0.24 |
| (powder) | | | | | | | | | | | | |
| Ca(OH)₂ | 5.0 | | | 26.1 | 69.2 | 5.1 | 62 | −2 | 3.0 | 0.0 | 1.2 | 0.24 |
| | Ca(OH)₂ | NaOH | KOH | Substitution of Ca(OH)₂ by NaOH and KOH | | | | | | | | |
| | 3.0 | 2.0 | | 45.3 | 56.6 | 17.7 | 84 | 20 | 2.2 | 2.9 | 1.1 | 0.23 |
| | 3.0 | 1.5 | 0.5 | 42.8 | 62.9 | 11.4 | 77 | 13 | 2.3 | 1.4 | 1.7 | 0.24 |
| | 3.0 | 1.0 | 1.0 | 35.9 | 65.7 | 8.6 | 70 | 6 | 2.3 | 0.9 | 2.2 | 0.23 |
| | 3.0 | 0.5 | 1.5 | 43.4 | 58.8 | 15.5 | 73 | 9 | 3.0 | 0.6 | 2.7 | 0.24 |
| | 3.0 | | 2.0 | 48.3 | 56.9 | 17.4 | 79 | 15 | 3.6 | 0.1 | 3.1 | 0.24 |
| | CaO | NaOH | NH4OH | Substitution of NaOH by NH₄OH | | | | | | | | |
| | 3.0 | 1.5 | 0.5 | 41.7 | 60.1 | 14.2 | 75 | 11 | 2.8 | 1.6 | 1.2 | 0.21 |
| | 3.0 | 1.0 | 1.0 | 35.6 | 55.9 | 18.4 | 74 | 10 | 2.6 | 0.8 | 1.2 | 0.23 |
| | 3.0 | 0.5 | 1.5 | 33.6 | 70.8 | 3.5 | 66 | 2 | 2.5 | 0.4 | 1.2 | 0.24 |
| | 3.0 | | 2.0 | 39.8 | 64.5 | 9.8 | 67 | 3 | 2.6 | 0.1 | 1.1 | 0.23 |
| | CaO | NaOH | MgO | Substitution of MgO by Ca(OH)₂ and NaOH | | | | | | | | |
| | | | 1.0 | 38.1 | 62.0 | 12.3 | 62 | −2 | 3.2 | 0.0 | 1.2 | 0.84 |
| | | | 2.0 | 39.1 | 67.1 | 7.2 | 64 | 0 | 2.7 | 0.0 | 1.2 | 1.37 |
| | | | 5.0 | 40.1 | 62.7 | 11.6 | 67 | 3 | 0.8 | 0.0 | 1.2 | 3.18 |
| | 3.0 | 1.0 | 1.0 | 38.7 | 54.7 | 19.6 | 75 | 11 | 3.2 | 1.0 | 1.1 | 0.95 |
| | 2.5 | 2.0 | 0.5 | 51.2 | 55.7 | 18.6 | 76 | 12 | 2.6 | 1.7 | 1.2 | 0.68 |
| | 2.0 | 2.0 | 1.0 | 36.0 | 56.4 | 17.9 | 77 | 13 | 2.0 | 1.5 | 1.1 | 0.77 |

Edible fiber measured as neutral detergent fiber;
DMD = Dry matter digestibility measured by 48 hour incubation in buffered rumen fluid

The addition of 5% magnesium oxide resulted in a chemical profile intermediate to dry calcium oxide and calcium hydroxide slurry with slightly reduced efficacy for improved dry matter digestion. Mixtures of calcium and magnesium hydroxides were less effective in combination with 2% sodium hydroxide as compared to calcium hydroxide by itself. It appears magnesium may reduce the efficacy of calcium hydroxide, but may still be included at low inclusion rates in order to provide the magnesium mineral.

### Example 5

### Characteristics of Lignocellulosics Contacted with Combinations of Hydrolyzing Agents

In this Example, a study was performed to evaluate the concentrations of hydrolyzing agents on solubilizing fiber, improving digestibility, and enhancing the nourishing mineral content in various biomasses. This Example used extrusion processing of the biomass and hydrolyzing agent as described in US Patent Application 2008022012, the contents of the entirety of which is incorporated by this reference, to treat the biomass with the hydrolyzing agent. Corn stover, wheat straw, and cottonseed hulls were the biomasses evaluated. Extrusion processing of the biomass was done at 2.27 kg/minute at 50% moisture and using either dry calcium oxide or sodium hydroxide in water to achieve 2.5 or 5% added base singly or in combination. Samples of treated and untreated biomass were retained and chemical composition and digestibility of dry matter was determined.

The results of this Example as shown in Table 6 and generally indicate that the hydrolyzing agents increased the dry matter digestion. Treatment of the biomasses with the hydrolyzing agents solubilized edible fiber and increased dry matter digestibility of the biomasses. A differential effect existed between the calcium oxide and sodium hydroxide treatments where the sodium hydroxide caused a greater increase in digestibility of dry matter, but a little less solublization of fiber as compared to calcium oxide. This effect was most noticeable with cottonseed hulls. The combination of calcium oxide and sodium hydroxide increased dry matter and fiber digestion, was intermediate for corn stover and wheat straw, and was improved for cottonseed hulls compared to the calcium oxide and sodium hydroxide singly.

TABLE 6
Effects of contacting lignocellulosics with soduim hydroxide,
calcium oxide, or both during continuous processing (extrusion).

| | | Concentration of base (% of dry weight) | | | | |
|---|---|---|---|---|---|---|
| | | added to ground lignocellulosics | | | | |
| | Control | during extrusion processing | | | | |
| CaO | 0 | 2.5 | | 5 | 2.5 | |
| NaOH | 0 | | 2.5 | | 2.5 | 5 |
| | Corn Stover | | | | | |
| Edible fiber | 90.7 | 77.4 | 81.5 | 65.0 | 66.1 | 65.1 |
| g/100 g of dry | | | | | | |
| weight | | | | | | |
| Solubilized, | | 13.3 | 9.2 | 25.7 | 24.6 | 25.6 |
| g/100 g of dry | | | | | | |
| weight | | | | | | |
| DM digestibility, | 48 | 53 | 65 | 66 | 67 | 78 |
| % | | | | | | |
| | Wheat straw | | | | | |
| Edible fiber | 83.9 | 73.0 | 76.4 | 69.9 | 71.6 | 65.5 |
| g/100 g of dry | | | | | | |
| weight | | | | | | |
| Solubilized, | | 10.9 | 7.5 | 14.0 | 12.3 | 18.4 |
| g/100 g of dry | | | | | | |
| weight | | | | | | |
| DM digestibility, | 51 | 61 | 70 | 68 | 74 | 84 |
| % | | | | | | |
| | Cottonseed Hulls | | | | | |
| Edible fiber | 83.8 | 78.5 | 83.1 | 71.3 | 74.9 | 79.7 |
| g/100 g of dry | | | | | | |
| weight | | | | | | |
| Solubilized, | | 5.3 | 0.7 | 2.5 | 8.9 | 4.1 |
| g/100 g of dry | | | | | | |
| weight | | | | | | |
| DM digestibility, | 41 | 44 | 47 | 39 | 57 | 46 |
| % | | | | | | |

DM digestibility measured by incubating samples for 48 hours in buffered rumen contents containing a polyculture of rumen microorganisms

Sodium hydroxide was more effective than calcium oxide, but is more dangerous to handle. Care must also be taken with sodium hydroxide in order to avoid excessive sodium in the final animal feed and possible salting of soils due to high sodium excretion by the animals. The combination of calcium oxide and sodium hydroxide reduced the dependence on a single ion and appeared useful for treating biomasses.

### Example 6

### Contacting Biomass with Sodium Carbonate and Calcium Oxide

In this Example, samples of finely ground corn stover were mixed with dry calcium oxide powder, sodium carbonate, or both. This Example evaluated whether the calcium oxide and sodium carbonate would react to form sodium hydroxide.

Samples of corn stover ground through a 127 mm screen in a tub grinder were mixed with 5% calcium oxide on a dry matter basis or a mixture of 3% calcium oxide and 2.6% sodium carbonate for comparing initial solublization of edible fiber. The calcium oxide (lime) was relatively coarse and poorly reactive. Water was added to the biomasses to achieve about 50% moisture. To compare the speed at which the hydrolyzing agents worked, samples were taken immediately from the mixed biomass and hydrolyzing agent and after 4 hours before being saturated with carbon dioxide gas to convert excess calcium hydroxide to calcium carbonate. Another sample was retained frozen and analyzed after a reaction time of about 3 days. The results are presented in Table 7.

TABLE 7
Fiber content of sheared biomass contacted with calcium oxide
or a combination of calcium oxide and sodium carbonate.

| | Control | 5% CaO | | 3% CaO + 2.6% NaCO2 | |
|---|---|---|---|---|---|
| | Insoluble | Insoluble | Edible Fiber | Insoluble | Edible Fiber |
| | Edible Fiber, | Edible Fiber, | Solubilized, | Edible Fiber, | Solubilized, |
| | g/100 g of OM | g/100 g of OM | grams | g/100 g of OM | grams |
| Initial | 84.4 | 81.5 | 2.9 | 79.5 | 4.9 |
| | | | | | +2.0 g vs CaO |
| 3 days | | 79.7 | 4.7 | 77.3 | 7.1 |
| | | | | | +2.4 g vs CaO |

When expressed on an organic matter (OM) basis, the treatments with the hydrolyzing agents solubilized edible fiber and the use of a combination of calcium oxide and sodium carbonate resulted in a faster reaction as compared to calcium oxide by itself. This suggests that sodium carbonate may be used in combination with hydrolyzing agents to increase the rate at which the hydrolyzing agent reacts with the lignocellulosics of the biomass, and that the combination of the sodium carbonate with the hydrolyzing agent improves the solublization of edible fiber as compared to using calcium oxide alone. This combination may allow the production of a strong hydrolyzing agent (such as sodium hydroxide) using materials that are safer to handle than sodium hydroxide itself

### Example 7

### Liquid Holding Characteristics of Treated Biomass

Corn stover bales were ground and treated as described in Example 1 using calcium oxide as the hydrolyzing agent. During treatment of the biomass, it was observed that a fine particle fraction discharged from the treatment process has physically separated from the rest of the treated biomass. The fine particle fraction appeared heterogeneous in botanical composition, the fine particle fraction appeared to be primarily stalk pith of the corn stover. Samples of the fine particle fraction were collected and evaluated for liquid holding capacity. As shown in Table 8, the fine particle fraction of treated corn stover had a greater liquid holding capacity as compared to untreated, sheared corn stover.

TABLE 8
Liquid holding capacity (LCH) of sheared stover and
fine fraction of treated, fine fraction of corn stover.

| | Uncontacted | Separated Fine Fraction |
|---|---|---|
| | (~12% moisture in | (10.5% moisture in |
| Liquid source | n test material) | test material) |
| Corn Steep Liquor | 6.75 | 11.75 |
| Corn Stillage | 7.70 | 12.60 |

Uncontacted stover and contacted stover were ground to 3.2 mm before testing
LHC is expressed on a g/g on an as is basis. Liquids were approximately 50% solids.

A fraction or fractions of treated corn stover exist which may be separated from the rest of the treated corn stover using methods such as air classification or sieving. This could provide an advantage for forming mixed feeds because large amounts of liquid feed ingredients with beneficial nutrient contents may be blended into the treated, liquid holding corn stover fraction. In essence, the treated, liquid holding corn stover fraction could substitute for fibrous residues such as corn pericarp (bran) or soy hulls, which are often used as carriers for liquid ingredients produced as co-products.

### Example 8

### Separation of Treated Stover for Feed Evaluation

The shearing or grinding of biomass may be an energy intensive process that uses a greater amount of energy per unit of mass for fine v. coarse shearing or grinding. Animals such as ruminants are able to use coarse fiber, and even benefit from having coarse fiber which stimulates chewing and production of saliva, which can naturally buffer rumen fermentation. Finely sheared or ground biomass may improve the mechanical handling properties of biomass and afford greater feed consumption. However, finely sheared or ground biomass may reduce the retention time of potentially digestible fiber in the gut which may decrease feed digestion. Thus, a range of particle sizes and characters may be advantageous for treated biomasses and in the overall formulation of feeds including treated biomasses and other feed ingredients.

A study was conducted to evaluate the effects of the continuous-shearing processing system on the efficacy of treatment within a particle size class. Corn stover was sheared and treated with a lime solution as described in Example 1. Samples of treated and untreated corn stover that had been stored anaerobically in plastic bags for 1 month were used in the trial. About 2 gallon volumes of biomass were separated by sieving (using ASAE standard S424.1) and the insoluble edible fiber content was measured. Results are presented in Table 9.

The screen size of the tub grinder used in the shearing-treating process affected the particle size distribution of the treated corn stover, with a greater cumulative weight of coarser particles being observed when the aperture of the shearing screen increased. The insoluble edible fiber content of untreated corn stover was similar across the particle sizes and treatment of the corn stover with the lime resulted in significant solublization of edible fiber for all particle sizes. The efficacy of treatment was better for finer particles, for which 20 grams or more of edible fiber was solubilized per 100 grams of dry weight. The finest particle size of corn stover (from the bottom pan) had a large proportion of fiber solubilized, such as when the 76 mm screen was used in the tub grinder.

TABLE 9
Effect of particle size on insoluble fiber content of corn stover after
treatment with lime.

| | | Insoluble Edible Fiber | | |
|---|---|---|---|---|
| | Cumulative | g/100 g of dry weight | | Solubilized, |
| | weight, % | Control | Contacted | g/100 g |
| Sheared, 76 mm | | | | |
| Sieve screen, in | | | | |
| 0.75 | 19.4 | 83.1 | 68.5 | 14.6 |
| 0.50 | 25.0 | 85.0 | 68.9 | 16.1 |
| 0.25 | 54.0 | 83.5 | 63.0 | 20.5 |
| 0.156 | 68.6 | 79.5 | 61.6 | 17.9 |
| 0.046 | 88.3 | 80.6 | 57.5 | 23.1 |
| Bottom | 100.0 | 78.2 | 42.4 | 35.8 |
| Sheared, 127 mm | | | | |
| Sieve screen, in | | | | |
| 0.75 | 25.1 | 85.4 | 68.1 | 17.3 |
| 0.50 | 36.4 | 81.7 | 70.1 | 11.6 |
| 0.25 | 63.4 | 69.8 | 69.4 | 0.4 |
| 0.156 | 76.6 | 85.4 | 59.3 | 26.1 |
| 0.046 | 93.0 | 81.7 | 57.9 | 23.8 |
| Bottom | 100.0 | 79.7 | 52.1 | 27.6 |
| Sheared, 176 mm | | | | |
| Sieve screen, in | | | | |
| 0.75 | 35.6 | 86.5 | 65.2 | 21.3 |
| 0.50 | 51.9 | 82.2 | 91.1 | -8.9 |
| 0.25 | 73.4 | 82.0 | 66.9 | 15.1 |
| 0.156 | 82.7 | 79.8 | 57.4 | 22.4 |
| 0.046 | 94.3 | 75.3 | 56.4 | 18.9 |
| Bottom | 100.0 | 70.4 | 41.9 | 28.5 |

The results of Table 9 show that the shearing/treatment process solubilized edible fiber across a range of particle sizes in the biomass. The use of a fine shearing/grinding in the treatment process of the present invention results in the accumulation of a fine particle fraction with less insoluble edible fiber or more soluble fiber and, thus, better digestibility. This fine fraction also has the advantageous property for material handling and its feed value may be improved to make it suitable for non-ruminants, such as gestating and/or growing swine.

### Example 9

### Use of Treated Biomass in Feed Blends

Studies were conducted to evaluate the utility of lime-treated corn stover for forming a composite feed. In one study, corn stover was sheared and treated using the system described in Example 1. Corn stover was sheared using a 127 mm screen in the tub grinder. Untreated and treated corn stover were used to form feed blends containing corn stover, modified corn wet distillers grains (MCWDG) at 50% moisture, and condensed fermented corn extractives known as corn steep liquor (CSL) at 50% moisture in a tumbling mixer. Water was added to the untreated corn stover to equalize moisture content. Table 10 shows the results of the study and indicates that feed mixtures containing treated corn stover had decreased insoluble edible fiber content which indicated that the treating process solubilized edible fiber, thus improving the digestibility and feed value of the feed. There was also an increased non-fiber carbohydrate content for the blends containing the treated corn stover as compared to the untreated corn stover. The non-fiber carbohydrates include a class of nutrients including soluble sugars which are digestible by the animal.

TABLE 10
Protein and edible fiber content of feed mixes
containing sheared-treated biomass contacted with hydrolyzing agent.

| | | | | | Insoluble Edible | | Non-Fiber | |
|---|---|---|---|---|---|---|---|---|
| | | | Crude Protein, | | Fiber, g/100 g of | | Carbohydrates, | |
| | | | % of dry weight | | dry weight | | g/100 g of dry | |
| Composition of | | | Stover Form in | | Stover Form in | | weight | |
| feed mixture, % as is | | | Feed Mix | | Feed Mix | | Stover Form in Feed Mix | |
| Stover | CSL | MWDGS | Untreated | Treated | Untreated | Treated | Untreated | Treated |
| 49 | 51 | 0 | 21 | 27 | 50 | 35 | 23 | 32 |
| 39 | 61 | 0 | 28 | 33 | 50 | 38 | 18 | 25 |
| 32 | 36 | 32 | 30 | 27 | 44 | 38 | 22 | 29 |
| 27 | 46 | 27 | 32 | 33 | 43 | 32 | 21 | 30 |
| 23 | 54 | 23 | 37 | 28 | 33 | 38 | 27 | 28 |
| 20 | 60 | 20 | 36 | 34 | 27 | 29 | 33 | 32 |

In another study, corn stover that was treated with lime in the continuous shearing-treating system using the 76 mm screen was used to form feeds in a high shear mixer to evaluate pH, nutrient composition, and physical form of the feeds. High shear mixing improved the handling characteristics of the feeds as compared to the tumbling mixer. The inclusion of the treated corn stover as a carrier raised the pH of the feeds as compared to the pH of the individual ingredients blended with the treated corn stover. Some of the feeds contained a high proportion of liquid ingredients (corn steep liquor) in the formulations which indicated that treated corn stover can be used as carriers for liquid in feeds and/or liquid feeds. A wide range of feeds may be formed based on the analyzed compositions described herein that would meet nutrient allowances for protein and calcium of many animals as shown in Table 11, yet still provide digestible carbohydrates for energy. Further, some of the feeds exhibit higher pH and such feeds could be used in feeds to buffer the gastrointestinal tract of animals fed acidic diets or diets that are fermented in the forestomach of ruminants that produce short chain fatty acids such as lactic, acetic, propionic, or butyric.

TABLE 11
Chemical compositions of feeds containing sheared corn stover treated with lime.

| Ingredient, % of mix dry weight | | | | | | | | |
|---|---|---|---|---|---|---|---|---|
| | Corn | Wet | Nutrient content | | | | | |
| Treated | Steep | Distillers | pH of | Dry | Crude | Insoluble | Non Fiber | |
| Stover | Liquor | Grains | Feed | Matter | Protein, % | Edible Fiber, | Carbohydrates, | Calcium, |
| (pH = 10.5) | (pH = 4.5) | (pH = 4.25) | Blend | (DM) % | of DM | g/100 g of DM | % of DM | % of DM |
| 70 | 30 | | 10.5 | 44 | 15 | 49 | 28 | 2.96 |
| 50 | 50 | | 7.00 | 40 | 24 | 40 | 29 | 2.38 |
| 30 | 70 | | 5.00 | 39 | 31 | 23 | 39 | 1.62 |
| 30 | 50 | 20 | 5.00 | 41 | 31 | 31 | 33 | 1.29 |
| 30 | | 70 | 5.50 | 46 | 22 | 45 | 27 | 1.33 |
| 50 | | 50 | 8.50 | 45 | 16 | 48 | 29 | 2.28 |
| 70 | | 30 | 10.50 | 43 | 12 | 51 | 28 | 3.19 |
| 30 | 20 | 50 | 5.50 | 44 | 24 | 40 | 30 | 1.63 |

This Example demonstrates the utility of treated corn stover in feeds. Various hydrolyzing agents may be selected and/or combined to align the mineral composition of treated corn stover with animal requirements for the minerals. Also, the selection of shearing/grinding equipment and optional separation of smaller sized particles of treated corn stover having unique characteristics may be selected in order to optimize feeds. Thus, the shearing/treating and mixing of various treated biomasses in combination with various co-products may be optimized to use treated biomasses to create feeds similar to distillers grains or corn gluten feed.

### Example 10

### Feed Value of Treated Biomasses

A feeding trial was conducted to evaluate the effect of hydrolyzing agents and method of storage of treated biomasses on the nutritive characteristics and feed value. Corn stover was sheared using a tub grinder fitted with a 25 mm screen. The sheared corn stover was conveyed to an open commodity bay for further processing. A portion of the sheared corn stover was contacted with a hydrolyzing agent in a batch process that included placing the corn stover in a feed mixer wagon, wetting the corn stover to about 50% moisture, and adding calcium oxide powder at 5% by weight while the corn stover was mixed with a chain-drag auger in the feed wagon. After about ten minutes of mixing, the treated corn stover was placed into a large plastic bag (Ag Bag), compressed, and stored anaerobically for at least 30 days before samples were collected.

Another portion of the sheared corn stover from the commodity bay were processed by continuous extrusion in a Readco Continuous Processor as described in US Publication 20080220125, but with the addition of a pre-wetting step to improve the flow of the sheared corn stover into the extruder. The sheared and pre-wetted corn stover was treated with calcium hydroxide or combinations of calcium hydroxide and sodium hydroxide at concentrations (weight % of biomass) of 5:0, 4:1, or 3:2 calcium oxide:sodium hydroxide. The moisture content of the sheared corn stover during treatment was about 50% and the residence time in the extruder was about 15 seconds. The treated corn stover was discharged from the extruder and stored in an open commodity bay without compacting under aerobic conditions during Spring and Summer months. Samples of aerobically stored, treated corn stover were collected after at least 30 days. The chemical characteristics of the treated and stored corn stover were evaluated and a beef cattle feeding trial was conducted to determine the feed value of the treated corn stover.

As shown in Table 12, an unexpected result occurred in that moisture was lost when the extruded corn stover was aerobically stored where the moisture content decreased to 13.7-15.4% as compared with the moisture content of about 41% of the treated corn stover right after extrusion. The aerobically stored corn stover was free of visible deterioration, which may be a result of the elevated pH of greater than 10. Although the anaerobically stored corn stover had a slight advantage in the amount of edible fiber solubilized, the aerobically stored corn stover is more economical to produce by avoiding the steps of compressing and covering.

TABLE 12
Solublization of edible fiber and dry matter digestion of corn stover
treated with hydrolyzing agents.

| | Sheared | | | | | |
|---|---|---|---|---|---|---|
| Item | stover | Corn stover contacted with inorganic hydrolyzing agents | | | | |
| Hydrolyzing agent | None | 5% CaO | 5% CaO | 5% CaO | 4% CaO: | 3% CaO: |
| | | | | | 1% NaOH | 2% NaOH |
| Method of contacting | None | batch | continuous | continuous | continuous | continuous |
| biomass | | | (extrusion) | (extrusion) | (extrusion) | (extrusion) |
| Method of storage | aerobic | anaerobic | none | aerobic | aerobic | aerobic |
| Moisture, % | 13.8 | 42.6 | 41.2 | 15.2 | 13.7 | 15.4 |
| Dry matter, % | 86.2 | 57.4 | 58.8 | 84.8 | 86.3 | 84.6 |
| pH | 6.9 | 9.0 | 12.0 | 10.0 | 10.2 | 10.4 |
| Edible fiber + lignin, % | 83.3 | 54.8 | 61.8 | 67.7 | 64.8 | 59.8 |
| of dry matter | | | | | | |
| Edible fiber solubilized, | | 28.5 | 21.5 | 15.6 | 18.5 | 23.5 |
| g/100 g of dry matter | | | | | | |
| Lignin, % of dry matter | 7.2 | 6.8 | 5.5 | 7.4 | 6.1 | 6.0 |
| Calcium, % of DM | 0.46 | 5.48 | 4.40 | 5.30 | 3.84 | 3.00 |
| Sodium, % of DM | 0.008 | 0.01 | 0.012 | 0.025 | 0.75 | 1.72 |
| Digestion of dry weight | 56 | 68 | 57 | 65 | 68 | 67 |
| after 48-h in vitro | | | | | | |
| enzyme exposure % | | | | | | |
| Improvement in dry | — | 12 | 1 | 9 | 12 | 11 |
| matter digestion (units) | | | | | | |

The pH of the aerobically stored treated corn stover was over 10 as shown in Table 12. At least 15 g/100 g of edible fiber was solubilized by all of the contacting/storage methods evaluated in this Example. In the continuous extrusion process, there appeared to be a benefit of using a combination of hydrolyzing agents, especially for improving the solublization of edible fiber. The effects of the various contacting/storage methods was also assessed by incubating samples of the treated corn stover in a buffered solutions containing ruminal micro-organisms that are known to possess an array of enzymes capable of hydrolyzing complex biomass. After 48 hours of in vitro incubation, there appeared to be an advantage of using a combination of calcium hydroxide and sodium hydroxide as the hydrolyzing agent as compared to calcium hydroxide by itself. Another advantage of combing the calcium hydroxide and sodium hydroxide is that the treated corn stover is more nourishing to the animal due to the amount of calcium and sodium present which approximates the recommended allowance of these minerals.

A beef cattle feeding trial was initiated to test the feed value of treated corn stover when used to substitute corn grain and untreated corn stover. Sixty beef steers were group-housed in a feed barn and fed total mixed rations for 60 days. The steers were housed in pens having 6 steers each, and two pens were assigned to each ration including the treated corn stover. The individual feed intake of the steers was monitored with a Gro-Safe electronic tag and each steer was individually weighed at the initiation and completion of the study. Cattle were processed to collect carcass data. The composition of the rations is shown in Table 13. The treated corn stovers were fed at 20% of the dry weight of the ration.

TABLE 13
Composition of diet used in feeding trial.

| | Control | Rations with |
|---|---|---|
| Item, % of ration dry weight | ration | contacted stover |
| Ground Corn | 55 | 35 |
| Modified wet distillers grains | 35 | 40 |
| Sheared stover - not contacted | 5 | 0 |
| Sheared and contacted stover | 0 | 20 |
| Supplement | 5 | 5 |

Contacted stover =
1. batch-contacted and anaerobically stored (5% CaO)
2. continuously contacted, aerobically stored (5% CaO)
3. continuously contacted, aerobically stored (4% CaO:1% NaOH)
4. continuously contacted, aerobically stored (3% CaO:2% NaOH)

Table 14 shows the performance of the beef cattle fed the treated corn stover. No difference was noted for the final weight of the cattle fed the control rations or the cattle fed the treated corn stover rations. The daily weight gain was not affected by treatment, but tended to be greater for cattle fed the control ration or the ration containing corn stover treated 3:2 calcium oxide:sodium hydroxide. The feed intake (P<0.01) decreased with rations containing the treated corn stover. The efficiency for feed conversion (gain:feed) tended (P=0.17) to improve for rations containing treated corn stover as compared to cattle fed the corn control ration. This unexpectedly indicates that treating the corn stover with the hydrolyzing agent improved the feed value of the treated corn stover, and the ration including the treated corn stover has a feed value equivalent to the ration containing high amount of corn grain. This was most noticeable when 5% calcium oxide or a ratio of 3:2 calcium oxide:sodium hydroxide as the hydrolyzing agent applied during continuous contact.

TABLE 14
Performance by beef cattle fed rations containing treated corn
stover as a substitute for corn grain and untreated biomass.

| | | | | | | | | Treatment | |
|---|---|---|---|---|---|---|---|---|---|
| | | | | | | 1 vs | | comparisons (p =) | |
| Control | Rations containing contacted biomass | | | | SEM | 2, 3, 4, 5 | 2 vs 3 | 3 vs 4 | 4 vs 5 |
| 1 | 2 | 3 | 4 | 5 | | | | | |
| none | 5% CaO | 5% CaO | 4% CaO: | 3% CaO: | | | | | |
| | | | 1% NaOH | 2% NaOH | | | | | |
| none | batch | continuous | continuous | continuous | | | | | |
| | | (extrusion) | (extrusion) | (extrusion) | | | | | |
| | anaerobic | aerobic | aerobic | aerobic | | | | | |
| 850 | 830 | 853 | 803 | 884 | 17 | 0.7 | 0.42 | 0.04 | <0.01 |
| 1054 | 1040 | 1042 | 1032 | 1056 | 16 | 0.52 | 0.84 | 0.65 | 0.33 |
| 2.74 | 2.56 | 2.59 | 2.46 | 2.77 | 0.21 | 0.52 | 0.84 | 0.64 | 0.33 |
| 17.85 | 15.00 | 15.10 | 14.81 | 15.98 | 0.69 | <0.01 | 0.70 | 0.76 | 0.22 |
| 0.153 | 0.165 | 0.173 | 0.157 | 0.179 | 0.01 | 0.17 | 0.66 | 0.27 | 0.12 |
| 655 | 644 | 628 | 637 | 659 | 13.5 | 0.39 | 0.85 | 0.63 | 0.30 |
| 92 | 83 | 67 | 50 | 83 | | 0.14 | 0.30 | 0.41 | 0.08 |

SEM = standard error of mean
* Denotes intial weight (P < 0.05) used as covariate
** Denotes intial weight (P = 0.06) used as covariate

The carcass weight of cattle was not affected by the treatment of the corn stover, but a numeric trend for more choice grading of carcasses existed when cattle were fed the corn control, the batch treated corn stover, or the corn stover treated with the ratio of 3:2 calcium oxide:sodium hydroxide as the hydrolyzing agent.

### Example 11

### Composition of Processed Corn Kernel Pericarp Fiber and Corn Stover

A processing study was initiated to evaluate alkaline treatment of corn fiber obtained from the grain fraction of corn (pericarp fiber) or from whole plant material with grain removed (corn stover). The processed materials were blended with feed ingredients, dried, and densified to form feed mixtures suitable for feeding beef cattle, dairy cattle, and swine. Contact of the pericarp fiber and the corn stover with mixtures of hydrolyzing agent was performed in a continuous fashion using a Littleford 300 L brand enclosed processing vessel. Water was added to the vessel to hydrate the fiber materials to 50% moisture, alkaline agents were added (2% CaO+3% NaOH wt:wt in the case of stover; 1.5% CaO+1.5% NaOH wt:wt in the case of pericarp weight), and the materials were processed in the vessel for 15 minutes. After treatment, a portion of the treated stover was separated using a Sweco vibrating separator fitted with a 5/16″ screen to separate the treated corn stover into a fine fraction and a coarse fraction. To form animal feed products, the treated fibers were mixed with a liquid feed (i.e., liquid corn steep liquor), wet distillers grains, or a combination thereof using a Littleford 150L brand mixer. Portions of the mixed products were belt-dried and densified by pelleting or piston briquetting.

The treatment with the hydrolyzing agents in the continuous mixing process in an enclosed vessel, at modest moisture concentration, and for a short reaction time of this Example surprisingly solubilized a high amount of edible fiber. In the case of the corn stover and the fine fraction of corn stover, approximately 20 percentage units of fiber was solubilized, whereas for the coarse fraction, about 16 units of the fiber was solubilized. In the case of corn kernel pericarp, treatment with hydrolyzing agent solubilized about 14 units of fiber. This Example demonstrates a novel method for separating whole stover into fine or coarse fractions having improved attributes, and the various sized materials could be suitably used for certain livestock feeds. For example, a coarser material may be more suitable for beef cows whereas the finer fraction may prove more suitable for dairy cows and gravid sows.

The processed fibers (stover and pericarp) contain levels protein below the allowances typically fed to livestock. However as shown in Table 15, blending with agricultural co-product ingredients results in feed mixtures with protein concentrations of 12 to 20% of the dry weight. The blending of the processed fibers with the other feed ingredients also improved the balance of fiber and protein, thereby making the blended materials more suitable for feeding to livestock such as beef, dairy, and swine. The drying and densification of the feed mixtures produced materials which are stable and may be stored for extended periods in bulk bins or commodity buildings. Such dried and densified materials may also be transported similar to those used for transporting commodities such as grains and oilseeds.

TABLE 15
Effects of processing characteristics of corn stover and corn kernal pericarp, and
composition of mixed feed products containing improved materials.

| | | | | Edible | | | Fiber |
|---|---|---|---|---|---|---|---|
| | | | CP, | fiber, | Lignin, | Ash, | solubilized, |
| | DM, | | % of | % of | % of | % of | percentage |
| | % | pH | DM | DM | DM | DM | units |
| Corn Stover Whole Material | | | | | | | |
| Untreated | 93 | 7.2 | 3.6 | 79.9 | 10.4 | 7.7 | |
| Hydrolyzed 3% CaO + 2% NaOH | | 9.8 | 2.8 | 59.1 | 8.1 | 16.1 | 20.8 |
| Corn Stover Fine Fraction | | | | | | | |
| Below 5/16″ screen - untreated | 93 | 7.6 | 3.5 | 78.2 | 9.4 | 10.0 | |
| Hydrolyzed 3% CaO + 2% NaOH | 99 | 9.9 | 2.6 | 57.5 | 7.3 | 17.3 | 20.7 |
| Corn Stover Coarse Fraction | | | | | | | |
| Above 5/16″ screen - untreated | 93 | 6.8 | 3.0 | 78.8 | 12.0 | 6.5 | |
| Hydrolyzed 3% CaO + 2% NaOH | 97 | 9.7 | 2.7 | 63.0 | 7.6 | 14.0 | 15.8 |
| Corn Pericarp Fiber | | | | | | | |
| Untreated | 90 | 4.4 | 11.3 | 43.7 | 7.2 | 1.0 | |
| Hydrolyzed | 95 | 9.8 | 9.4 | 29.7 | 3.2 | 9.8 | 14.0 |
| 1.5% CaO + 1.5% NaOH | | | | | | | |

Nutrient characteristics of feed mixtures containing improved fibers

| | | | | | | |
|---|---|---|---|---|---|---|
| Whole corn stover + WDG + CSL | 94.1 | 9.1 | 12.6 | 51.5 | 9.6 | 14.8 |
| (70:15:15 on dry wt basis) | | | | | | |
| Corn stover fine fraction + CSL | 93.5 | 9.2 | 13.1 | 51.5 | 6.4 | 15.5 |
| (70:30 on dry wt basis) | | | | | | |
| Corn fiber pericarp + CSL | 89.8 | 7.6 | 20.2 | 25.3 | 5.4 | 9.5 |
| (70:30 on dry wt basis) | | | | | | |

DM = dry matter;
CP = crude protein;
WDG = wet distillers grains;
CSL = corn steep liquor

### Example 12

### Separation and Processing Schemes for Corn Stover Residue

Improved methods for collection of crop residues is an active area of study with many investigations aimed at developing new equipment or processes to optimize the amount or quality of material removed from the field. One method uses a modified combine head which permits the simultaneous collection of the grain and the material other than grain (MOG). For corn, this MOG includes the collected portion of the corn plant, other than the grain, which runs through the combine. In essence, the MOG is corn stover having less corn stalks since the corn stalks are not picked up by a combine. The grain is handled by conventional methods while the MOG is formed into bales. Compared with corn stover collected by conventional raking and baling, the MOG material may have favorable properties because more husk, leaf, and cob are collected relative to stalk, and MOG has less soil contamination.

To assess the responsiveness of MOG to the processing technologies of the present invention, a trial was conducted using bales of stover collected by conventional raking and baling, and bales of MOG. The conventional stover and MOG were comminuted in a commercial tub grinder to reduce the particle size of materials. Calcium hydroxide solution was applied using the application manifold described herein. The lime suspension was applied at 5% CaO on a wt:wt basis with a target of 50% moisture during processing. The stover was continuously ground and processed at about 750 lbs per minute and the MOG was processed at about 750 lbs pounds per minute. The processed material was stored in a pile under aerobic conditions after treatment. Samples of processed materials were collected one day after treatment and submitted to the laboratory for assay within 10 days of treatment. The results of the trial are presented in Table 16.

TABLE16
Effect of treatment with hydrolyzing agent on composition and
digestibility of stover and Material Other than Grain (MOG).

| | Untreated | | Treated | |
|---|---|---|---|---|
| | Stover | MOG | Stover | MOG |
| Moisture, % | 29 | 29 | 54 | 58 |
| Total edible fiber and lignin, % of DM | 81.7 | 83.5 | 68.6 | 72 |
| Edible fiber solubilized, % | | | 13.1 | 11.5 |
| Lignin, % of DM | 10.2 | 7.3 | 8.4 | 6.0 |
| Ash, % of DM | 9.4 | 3.7 | 22.4 | 13.4 |
| Ca, % of DM | 0.46 | 0.25 | 4.35 | 4.30 |
| Estimated rumen digestion of DM, % | 56 | 67 | 70 | 73 |
| increase in DM digestion, units | | | 14 | 6 |
| Geometric mean particle size, mm | 6.6 | 9.6 | | |

Contact with the hydrolyzing agent at about 50% moisture under aerobic storage conditions was sufficient to produce the observed solublization of edible fiber presented in Table 16. The MOG had less ash and was inherently more digestible as compared with the conventional stover. Treatment with lime solubilized edible fiber and improved the digestibility of conventional stover and MOG, but the MOG tended to be less responsive to the processing scheme which was used in this trial. This Example demonstrated that continuous processing schemes have demonstrated useful for improving conventional stover may also be suitably used to improve the feed value of materials such as MOG.

### Example 13

### Separation of Ground Stover for Animal Feed

The inclusion of forage amount and type in animal diets varies greatly across class of livestock and stage of production within livestock classes, with higher producing animals typically fed lesser amounts of forage and higher amounts of starchy concentrate feeds, such as corn grains. However, the feeding of high concentrate diets to high producing livestock, such as the lactating dairy cow, may cause digestive upsets, poor performance, and even death from metabolic acidosis. Therefore, rations of high producing livestock will contain some proportion of forage with emphasis placed on the physical and chemical characteristics of the forage so as to optimize intake, digestion, and health of the animal. Generally, feeding rations that contain high amounts of insoluble fiber having long particle length tends to diminish intake of the total ration, thereby limiting the intake of nutrients essential for growth or milk production. Therefore, it is important to assess the digestibility and particle characteristics of forages and crop residues to determine their potential utility in feed rations.

In order to make these assessments, the materials of Example 12 were separated using a trommel (Vermeer Trommel—Model TR521) fitted with a 0.25 inch screen, thereby producing a coarse (>0.25″) and a fine (<0.25″) fraction for conventional stover and MOG. The separation of the treated materials was accomplished within 24 hours after the materials had been continuously ground and treated with lime. The characteristics of the various fractions are presented in Table 17.

TABLE 17
Composition of conventional stover and MOG after treatment and separation.

| Untreated | | Treated | |
|---|---|---|---|
| Coarse | Fine | Coarse | Fine |

| | stover | MOG | stover | MOG | stover | MOG | stover | MOG |
|---|---|---|---|---|---|---|---|---|
| Moisture, % | 32 | 23 | 31 | 27 | 62 | 47 | 61 | 53 |
| Dry matter, % | 68 | 77 | 69 | 73 | 38 | 53 | 39 | 47 |
| Edible fiber and lignin, % of DM | 84.1 | 87.6 | 76.0 | 79.0 | 59.4 | 79.6 | 60.1 | 70.8 |
| Edible fiber solubilized, units | | | | | 24.7 | 8.0 | 15.9 | 8.2 |
| Lignin, % of DM | 10.5 | 7.4 | 9.4 | 6.3 | 7.8 | 4.8 | 9.1 | 7.5 |
| Ash, % of DM | 8.5 | 3.1 | 14.5 | 4.6 | 25.2 | 91 | 36.0 | 17.5 |
| Ca, % of DM | 0.83 | 0.33 | 1.15 | 0.52 | 5.49 | 2.88 | 6.73 | 5.27 |
| 48 h in vitro rumen DM, % | 56 | 65 | 60 | 64 | 73 | 68 | 78 | 73 |
| Increase in digestion, units | | | | | 17 | 3 | 18 | 9 |
| Geometric mean particle size, mm | 23.0 | 22.3 | 4.3 | 5.1 | 7.6 | 15.4 | 2.2 | 3.2 |

As discussed in example 12, contacting the materials with hydrolyzing solution was more efficacious for corn stover as compared to MOG, as evidenced by the lesser amount of edible fiber solubilized for MOG versus stover. Materials were successfully separated into coarse and fine fractions as evidenced by the larger mean particle size for the coarse versus the fine fractions. The proportion of total weight in the two fractions was estimated to be approximately 60 to 40 or 40 to 60 percent by weight between coarse and fine fractions. The conventional stover was initially higher in ash and therefore there was a greater accumulation of ash in the fine fraction of treated stover as compared with MOG. The ash could be separated by further screening or optionally this fraction could be used as a source of fertilizer, for example, further demonstrating a utility for separating the materials into preferred particle sizes or chemical characteristics. The fine fraction of conventional and MOG exhibited the desirable digestion characteristics and these materials could be used as feed for dairy cattle and potentially for gravid sows or fattening pigs, if blended with other feeds to balance for protein and other nutrients.

The present invention has been described with reference to certain exemplary and illustrative embodiments, compositions and uses thereof. However, it will be recognized by persons having ordinary skill in the art that various substitutions, modifications or combinations of any of the exemplary embodiments may be made without departing from the scope of the invention. Thus, the invention is not limited by the description of the exemplary and illustrative embodiments, but rather by the appended claims.

What is claimed is:

1. A continuous process for producing an animal feed, the process comprising:
comminuting biomass into smaller fractions;
contacting the smaller fractions with a slurry comprising an inorganic hydrolyzing agent and water, such that a moisture content of the contacted smaller fractions is between 25-55%, thus producing a treated biomass;
storing the treated biomass for at least 24 hours; and
feeding the stored biomass to an animal.

2. The continuous process of claim 1, wherein the biomass is corn stover.

3. The continuous process of claim 1, wherein comminuting the biomass comprising grinding, shredding, or grinding and shredding the biomass.

4. The continuous process of claim 1, further comprising moving the smaller fractions from a device for comminuting the biomass and onto a device configured for contacting the smaller fractions with the slurry.

5. The continuous process of claim 1, wherein contacting the small fractions with the slurry comprises:
pumping the slurry from a container to a means for spraying the slurry on the smaller fractions; and
spraying the slurry on the smaller fractions.

6. The continuous process of claim 1, further comprising collecting the biomass from a field.

7. The continuous process of claim 6, wherein the collecting the biomass comprises raking and baling the biomass from the field.

8. The continuous process of claim 6, wherein the collecting the biomass comprises baling the biomass from a combine.

9. The continuous process of claim 1, wherein the inorganic hydrolyzing agent is selected from the group comprising an oxide, a hydroxide, a carbonate, a bicarbonate, a percarbonate, calcium oxide, calcium hydroxide, sodium hydroxide, potassium hydroxide, magnesium oxide, magnesium hydroxide, lime, sodium carbonate, sodium bicarbonate, sodium percarbonate, potassium carbonate, potassium bicarbonate, potassium percarbonate, and combinations of any thereof.

10. The continuous process of claim 1, wherein the biomass is stored aerobically.

11. The continuous process of claim 1, wherein the biomass is stored anaerobically.

12. The continuous process of claim 1, further comprising mixing an acidic, agricultural co-product with the treated biomass.

13. The continuous process of claim 1, wherein the acidic, agricultural co-product is liquid.

14. The process of claim 1, wherein the inorganic hydrolyzing agent is lime.

15. The process of claim 1, wherein the moisture content is between 45-55%.

16. The process of claim 1, wherein the process is carried out at ambient pressure and ambient temperature.

17. The process of claim 1, wherein the process is able to process at least 350 kilograms of the corn stover per minute.

18. The process of claim 1, further comprising separating the smaller fractions into a fine fraction and a coarse fraction.

19. A system for converting biomass into a more digestible animal feed, the system comprising:
a device for comminuting biomass into smaller fractions;
a conveyer for moving the smaller fractions from the device; and
means for spraying an aqueous solution comprising an inorganic hydrolyzing agent onto the smaller fractions on the conveyer.

20. The system of claim 19, further comprising an apparatus for separating the smaller fractions into a coarse fraction and a fine fraction.
